(19) United States
(12) Patent Application Publication
(10) Pub. No.: US 2005/0131733 A1
(43) Pub. Date: Jun. 16, 2005

(54) Sealable individual bar coded packets

(76) Inventor: Allen Lubow, Brooklyn, NY (US)

Correspondence Address: BROWN, RAYSMAN, MILLSTEIN, FELDER & STEINER LLP, 900 THIRD AVENUE, NEW YORK, NY, 10022, US

(21) Appl. No.: 10/511,864

(22) PCT Filed: Apr. 17, 2003
(86) PCT No.: PCT/US03/12425

Related U.S. Application Data
(60) Provisional application No. 60/373,740, filed on Apr. 17, 2002.
(60) Provisional application No. 60/390,254, filed on Jun. 19, 2002.
(60) Provisional application No. 60/392,060, filed on Jun. 25, 2002.
(60) Provisional application No. 60/341,763, filed on Dec. 17, 2001.

(51) Int. Cl. G06F 17/60

(52) U.S. Cl. 705/2

(57) ABSTRACT

A foldable and sealable packet is provided which contains a bar coded symbol, such as a RSS/CS bar code. The packet preferably also contains human readable information. In one embodiment the packet is used to contain medication for a patient. In such case, patient caregiver instructions are received electronically, medication is dispensed, and the foldable and sealable packet is produced, and the medication is contained therein. The foldable and sealable packet, with the medication contained therein, is provided to the patient.

### CROSS-REFERENCE TO RELATED APPLICATIONS

The present invention is based on and claims priority to U.S. Provisional Patent Application Ser. No. 60/373,740 entitled “SEALABLE INDIVIDUAL BAR CODED PACKETS” and filed on Apr. 17, 2002, U.S. Provisional Patent Application Ser. No. 60/390,254 entitled “SEALABLE INDIVIDUAL BAR CODED PACKETS WITH EXTENDED GRAPHICS” and filed Jun. 19, 2002, U.S. Provisional Patent Application Ser. No. 60/392,060 entitled “SYSTEM AND METHOD FOR BAR CODING BLISTER PACK PACKAGING” and filed Jun. 25, 2002, and PCT Patent Application Serial Number PCT/US02/41 entitled “MODIFIED BAR CODE SUBSTITUTING FOR DOUBLE BAR CODED LABEL” and filed Dec. 17, 2002 which claims priority to U.S. Provisional Patent Application Ser. No. 60/341,763 entitled “MODIFIED BAR CODE SUBSTITUTING FOR DOUBLE BAR CODED LABEL” and filed Dec. 17, 2001, the entire contents of all of which are hereby incorporated by reference.

### BACKGROUND OF THE INVENTION

In the prior art, medication is distributed in containers such as plastic vials, bottles, and packets. These containers are potentially expensive to manufacture and also produce considerable waste. Further, in a hospital or nursing home, ambulatory care facility, outpatient facility environment, or in another patient care facility (collective referred to herein as a “patient care facility”), individual servings of tablet form medications are typically dropped into a plastic cup and the tablets are later consumed. Typically, a piece of paper containing information directed to the patient and the medication, for example in the form of a tablet, is included in the cup. After the medication is consumed, the piece of paper and/or label is placed in the patient's medical record chart at the hospital or other medical related facility.

Also in the prior art, a pharmacy associated with a patient care facility typically prepares medications for patients in blister pack form, for example, a one month supply. Typically during rounds, a nurse arrives at a patient room and ensures that the patient is present. The charts for the patient are referenced, and the medication and/or procedures for the patient are noted and prepared. Tablets are removed from the blister pack and put in a paper cup and administered to the patient.

FIG. 1 illustrates an example of how the above-identified prior art medication distribution processes can create confusion and result in errors. As shown therein, a pharmacy, such as a pharmacy department in a hospital, provides medication in blister packs. After the medicine in the blister packs is distributed to floors, a nurse or other patient caregiver separates the medicine from the blister pack packaging and prepares each patient's dosage. There is great potential for error when medications are taken from the original pharmacy packaging, chosen by nurses or caregiver and delivered to patient. Typical errors include the wrong patient, medication, dosage or time of day.

Bar codes are typically printed on individual items and on containers enclosing a number of items. Bar codes contain information encoded in bars and spaces of various widths and arranged in predetermined patterns. When a bar code is scanned by a bar code reading device (e.g., a laser scanner), the bars and spaces are usually crossed by the scanning beam along a horizontal plane, or alternatively, rastered or scanned omni-directionally. Bar code technology, including printers, scanners and decoders encompass symbologies (i.e., bar code languages) to encode data that are optically read, thus producing machine-readable symbols that capture visual images of the symbologies and convert them to computer-compatible digital data. The size of a bar coded label is determined in part by the type of coding used, by the size of the individual bars and spaces, or on the data-matrix or the composite symbology. The amount of information encoded in a bar code is constrained by the size limitations of the bar code.

There are many different bar code symbologies. Each symbology has its own set of rules for character (e.g., letter, number, punctuation) encoding, error checking, printing, and decoding requirements. The various bar code symbologies differ in the ways they represent data and in the type of data they can encode. Some only encode numbers, others encode numbers, letters and a few punctuation characters, still others encode the 128-character and even 256-character ASCII character sets. The newest symbologies include options to encode multiple languages and allow user-defined encoding of special or additional data. These new symbologies even allow, through deliberate redundancies, reconstruction of data if the symbol is damaged.

The conventional bar code symbol is “one-dimensional,” i.e., bars and spaces extend only in a single direction. One-dimensional bar codes are limited in the amount of data that can be encoded therein. Increasingly, a need exists for bar codes to contain more information than conventional bar code symbols. In response to this need, reduced space symbology (RSS) and composite symbology (CS) bar codes have been developed. RSS bar codes are one-dimensional, extending in one direction. Several variants of RSS exist including stacked, limited and expanded which have, inter alia, the ability to encode additional data beyond a basic, short identifier that is usually printed with bar codes. The second symbology, CS, consists of a one-dimensional symbol paired with, and in some cases logically linked, to a two-dimensional symbol printed directly above it. The composite, two-dimensional symbol is known in the art as a PDF 417 symbol or a UCC/EAN-128 specific variant of MICRO PDF 417. MICRO PDF 417 is a version of PDF 417 which is designed for small item marking. Currently, RSS/CS bar codes are defined having a data capacity ranging from 56 characters to 2,361 characters. In time, the data capacity is likely to increase.

RSS/CS bar codes effectively replace the need for external computer databases to be referenced after a value, for example an UPC item number, is extracted from a one dimensional bar code. Prior to the development of RSS/CS bar codes, after a value was extracted from a single dimension bar code, data were referenced in computer database(s) to provide associated details with the extracted value. RSS/CS bar codes, in contrast, contain much of the associated data previously stored in a collateral database. The RSS/CS bar code is, essentially, a database itself.

### SUMMARY OF THE INVENTION

The present invention provides a foldable and sealable packet comprising folding perforations imprinted on the packet to define locations for folding, a sealant for maintaining the shape of the packet after the packet is folded at the folding perforations and a bar code, such as a RSS/CS barcode, containing information directed to at least contents of the packet. After the packet is folded and partially sealed, the packet is formed to become a container to receive the contents.

Other features of the foldable and sealable packet include storing the medication in the packet, wherein the medication includes at least one of capsules, tablets, gelcaps, dissolving strips, and caplets. Further, the foldable and sealable packet comprises human readable information printed thereon. Additionally, the human readable information is directed a patient who is intended to receive the packet, the contents of the packet, and/or instructions for opening the packet.

Moreover, the foldable and sealable packet comprises an image that represents the contents of the packet. Further, the foldable and sealable packet further comprises a polycoat portion. The foldable and sealable packet also comprises a tear off perforation portion that enables the removal of individual foldable and sealable packets in a strip of foldable and sealable packets.

In one example, the foldable and sealable packet, is formed as blister packs, wherein the blister packs are formed with at least one of a paper and film portion having an ink layer disposed thereon, and wherein the ink layer is adapted to be removed by a laser. Further, the RSS/CS bar code is formed in the at least one of paper and film by the removal of the ink by the laser.

Further, the foldable and sealable packet are formed in a plurality of foldable and sealable packets, wherein the first packet comprises information regarding the remaining ones of the foldable and sealable packets in the strip.

Further, the foldable and sealable packet comprises a removable tab portion. The removable tab portion comprises a CS portion of a RSS/CS bar code, and a RSS portion of the RSS/CS barcode and the portion of the foldable and sealable packet is adjacent to the tab portion comprises an identical CS portion and a portion of the RSS portion. When removed, the removable tab comprises a complete copy of the RSS/CS barcode on the portion of the foldable and sealable packet adjacent to the tab portion.

Also, the foldable and sealable packet further comprises a at least partially transparent window that enables a person to see the contents of the foldable and sealable packet.

Additionally, the foldable and sealable packet, further comprising at least one shape printed on the foldable and sealable packet, wherein the shape represents information directed to at least one of the contents of the foldable and sealable packet and the person who receives the foldable and sealable packet. The at least one shape is formed as at least one of a polygon, a bar, and a circle.

The information represented by the shape regards at least one of dosage, frequency of use, time of day for ingestion and warnings directed to the contents of the foldable and sealable packet.

The present invention further regards a method for producing a foldable and sealable packet, and comprises storing electronic patient information in a database, storing electronic medication information regarding at least one of a plurality of medications, providing at least one of the electronic patient information and the electronic medical information to a patient caregiver, receiving electronic instructions comprising instructions directed to medication for the patient from the patient caregiver, printing at least a bar code on the foldable and sealable packet, dispensing at least one medication in the foldable and sealable packet and folding and sealing the foldable and sealable packet such that the packet becomes a container for the at least one medication.

The invention further comprises referencing at least one Internet web page to discover information directed to the at least one medication, and printing human readable information on the foldable and sealable packet. The human readable information comprises at least one a medication warning, drug recall information, batch number, lot number, patient information, medication fill date, medication quantity, dosage, and directions for consumption.

The invention further regards a method for dispensing medication to a patient, comprising electronically receiving caregiver instructions representing information regarding medication for the patient, printing of a foldable and sealable packet, folding of the foldable and sealable packet, dispensing at least one medication into the foldable and sealable packet, sealing the foldable and sealable packet and distributing the foldable sealable packet containing the at least one medication to the patient. The step of distributing the medication further comprises reading a bar code image on a wrist band worn by the patient to extract wrist band information, reading a bar code image on the foldable and sealable packet to extract content information representing the contents of the foldable and sealable packet, comparing the wrist band information with the content information, and providing the patient with the foldable and sealable packet containing the medication after confirming the wrist band information corresponds with the content information.

Other features and benefits are provided below.

### DESCRIPTION OF THE DRAWING(S)

For the purposes of illustrating the invention, there is shown in the drawings a form which is presently preferred, it being understood, however, that the invention is not limited to the precise arrangements and instrumentalities shown. The features and advantages of the present invention will become apparent from the following description of embodiments of the invention that refers to the accompanying drawings, in which:

FIG. 1 illustrates confusion that is typically incurred in prior art medicine distribution systems;

FIG. 2 shows an example hardware embodiment in accordance with the present invention;

FIG. 3 shows sample components of an information processor and user terminal in accordance with the present invention;

FIG. 4 shows an example sealable individual bar coded packet in accordance with the present invention;

FIGS. 5A and 5B show a sealable individual bar coded packets after folding and sealing have occurred;

FIGS. 6A, 6B and 6C show an example sealable individual bar coded packet during the process of folding and sealing;

FIG. 7 shows an example web of a roll of sealable individual bar coded packets;

FIG. 8 shows an example strip of sealable individual bar coded packets that can be folded in to an accordion shape;

FIG. 9 shows an example blister pack packaging that is used in accordance with the present invention;

FIG. 10A-10E show a collection of blister pack packaging that is available via the present invention;

FIG. 11A shows an individual blister pack in accordance with an embodiment of the present invention;

FIG. 11B shows a plurality of blister packs combined in accordance with the present invention;

FIG. 12 shows an example sealable individual bar coded packet having a removable tab portion;

FIG. 13 shows a plurality of shapes that are printed on labels in accordance with the present invention;

FIG. 14 shows a plurality of software control modules used in accordance with the present invention; and

FIG. 15 is a flow chart identifying sample steps associated with the present invention.

### DETAILED DESCRIPTION OF EMBODIMENTS OF THE INVENTION

The present invention is directed to a system and method for improving distribution of medication. In accordance therewith, the present invention provides for a plurality of computer-related hardware and software applications to receive and process information directed to distribution of medication. Further, the invention is directed to providing a sealable bar coded label that is folded and glued or otherwise formed such that the label itself becomes a container for one or more tablet form medications.

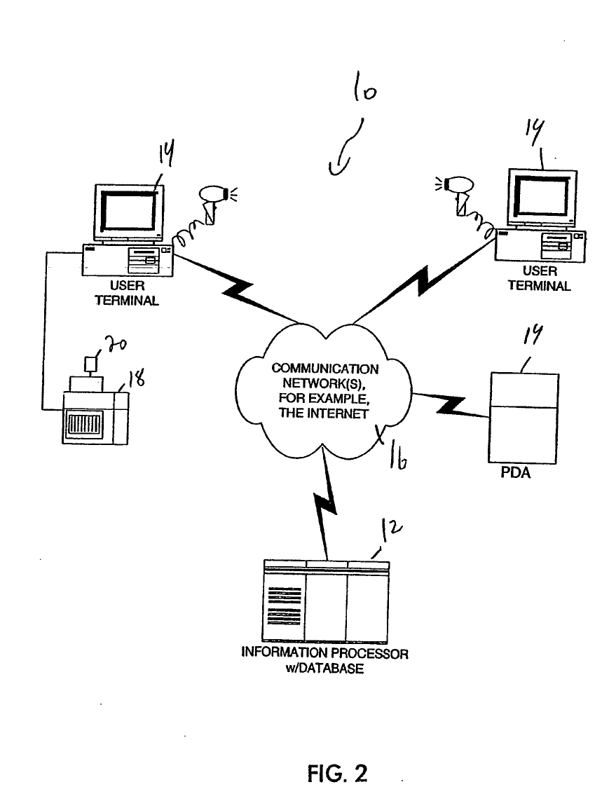

Referring to the drawings in which like reference designators refer to like elements there is shown in FIG. 2 an example of a first preferred embodiment including a hardware arrangement for producing sealable individual bar coded packets, and referred to herein, generally as system 10. System 10 preferably comprises at least one information processor 12 and at least one user terminal 14, each of which are coupled to communication network 16. Information processor 12 preferably includes all databases necessary to support the present invention. However, it is contemplated that information processor 12 can access any required databases via communication network 16 or any other communication network to which information processor 12 may be coupled. Communication network 16 is preferably a global public communication network such as the Internet, but can also be a wide area network (WAN), local area network (LAN), or other network that enables two or more computers to communicate with each other.

In the preferred embodiment, information processor 12 and user terminal 14 are any devices that are capable of sending and receiving data across communication network 16, e.g., mainframe computers, mini computers, personal computers, laptop computers, personal digital assistants (PDA) and Internet access devices such as Web TV. In addition, user terminals 14 are preferably equipped with a web browser, such as MICROSOFT INTERNET EXPLORER, NETSCAPE NAVIGATOR and the like. Information processor 12 and user terminals 14 are coupled to communication network 16 using any known data communication networking technology.

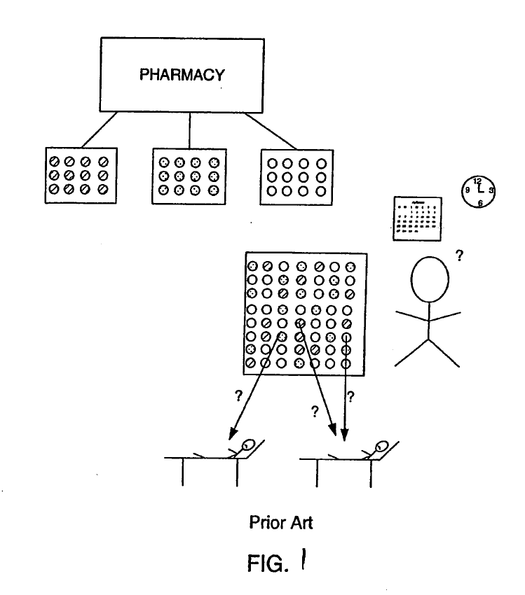

Also shown in FIG. 1, printer 18 is preferably used to produce sealable individual bar coded packets, and may be of a variety of printer types, including, for example, thermal printers, laser printers, impact printers and the like. Printer 18 is preferably used, at least in part, for high volume printing. In other words, printer 18 may print thousands and even millions of labels, including bar codes, in a single day.

In accordance with the present invention, printer 18 produces sealable individual bar coded packets 20 that are used for medications. As used herein, the term medications generally refers to medicine that can be consumed by a patient. For example, medications include tablets, capsules, caplets, gelcaps and other types of medicine that is consumed orally.

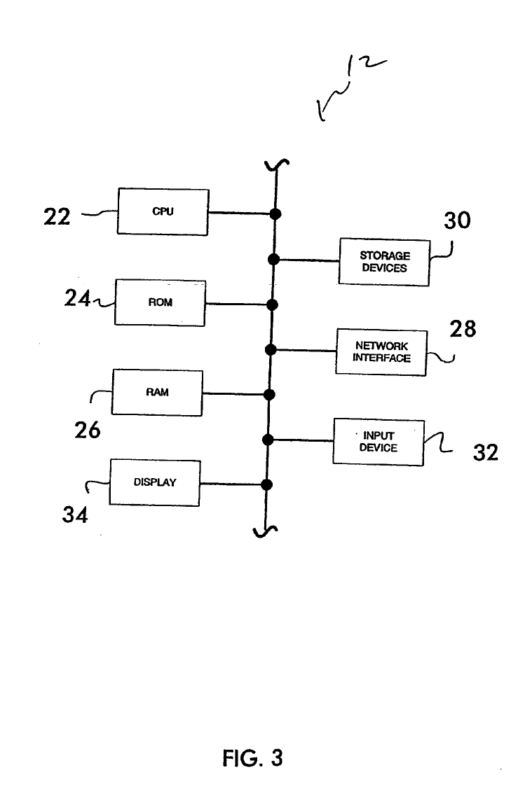

As shown in FIG. 3, the functional elements of each information processor 12 include one or more central processing units (CPU) 22 used to execute software code and control the operation of information processor 12, read-only memory (ROM) 24, random access memory (RAM) 26, one or more network interfaces 28 to transmit and receive data to and from other computing devices across a communication network, storage devices 30 such as a hard disk drive, floppy disk drive, tape drive, CD ROM or DVD for storing program code, databases and application data, one or more input devices 32 such as a keyboard, mouse, track ball, microphone and the like, and a display 34.

The various components of information processor 12 need not be physically contained within the same chassis or even located in a single location. For example, storage device 30 may be located at a site which is remote from the remaining elements of information processor 12, and may even be connected to CPU 22 across communication network 16 via network interface 28. Information processor 12 include a memory equipped with sufficient storage to provide the necessary databases, forums, and other community services as well as acting as a web server for communicating hypertext markup language (HTML), Java applets, Active-X control programs and the like to user terminals 14. Information processor 12 are preferably arranged with components, for example, those shown in FIG. 3, suitable for the expected operating environment of information processor 12. The CPU(s) 22, network interface(s) 28 and memory and storage devices are selected to ensure that capacities are arranged to accommodate expected demand.

As used herein, the term “link” refers to a selectable connection from one or more words, pictures or other information objects to others in which the selectable connection is presented within the web browser. The information object can include sound and/or motion video. Selection is typically made by “clicking” on the link using an input device such as a mouse, track ball, touch screen and the like. Of course, one of ordinary skill in the art will appreciate that any method by which an object presented on the screen can be selected is sufficient.

The functional elements shown in FIG. 3 (designated by reference numerals 22-34) are the same categories of functional elements present in user terminals 14. However, not all elements need be present, for example, storage devices in the case of PDA's and the capacities of the various elements are arranged to accommodate the expected user demand. For example, CPU 22 in user terminal 14 may be a smaller capacity CPU than the CPU present in the information processor 12. Similarly, it is likely that information processor 12 will include storage devices of a much higher capacity than storage devices present in user terminals 14.

Of course, one of ordinary skill in the art will understand that the capabilities of the functional elements can be adjusted as needed. The nature of the invention is such that one skilled in the art of writing computer executable code (i.e., software) can implement the described functions using one or more of a combination of popular computer programming languages and developing environments including, but not limited to C++, Visual Basic, Java, HTML and web application development applications.

It is contemplated that system 10 is arranged such that user terminals 14 communicate with and display data received from information processor 12 using any known communication and display method, for example, using a non-Internet-browser viewer coupled with a local area network protocol such as the Internet Packet Exchange (IPX), dial-up, third-party, private network or a value added network (VAN).

It is further contemplated that any suitable operating system can be used on information processor 12 and user terminal 14, for example, DOS, WINDOWS 3.x, WINDOWS 95, WINDOWS 98, WINDOWS NT, WINDOWS 2000, WINDOWS ME, WINDOWS CE, POCKET PC, WINDOWS XP, MAC OS, UNIX, LINUX, PALM OS and any other suitable operating system.

As used herein, references to displaying data on user terminal 14 refers to the process of communicating data to the terminal across communication network 16 and processing the data such that the data is viewed on the display 34, for example by using a web browser and the like. As is common with web browsing software, the display screen on user terminals 14 present sites within the system 10 such that a user can proceed from site to site within the system by selecting a desired link. Therefore, each user's experience with system 10 is based on the order with which they progress through the display screens. Graphic controls are preferably available in the display screens and modules to initiate data processes, and to provide convenient navigation between the display screens and modules of system 10. In other words, because the system is not completely hierarchical in its arrangement of display screens, users can proceed from area to area without the need to “backtrack” through a series of display screens. For that reason, and unless stated otherwise, the following discussion is not intended to represent any sequential operation steps, but rather to illustrate the components of system 10.

Form of Sealable Individual Bar Coded Labels

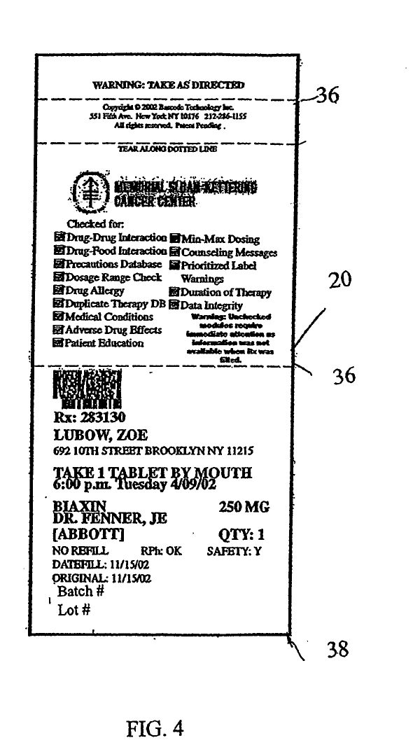

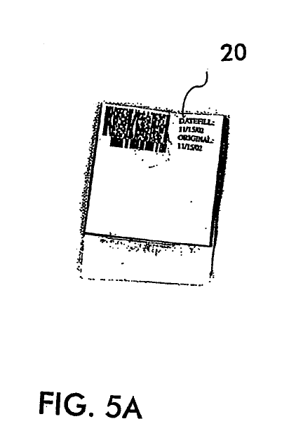

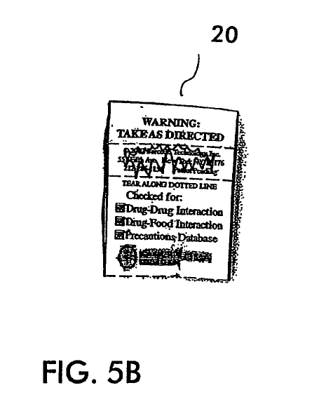

FIG. 4 shows an example sealable individual bar coded packet 20 prior to being folded, provided with medication, and sealed for delivery. The example sealable individual bar coded packet 20 shown in FIG. 4 contains folding perforations 36 which define locations to define where folding and/or sealing processes occur. Further, sealable individual bar coded packet 20 comprises tear off perforations 38 which define where, in strip of continuous sealable individual bar coded packets 20, one sealable individual bar coded packet ends and another begins. FIGS. 5A and 5B illustrate the front and back, respectively, of an example sealable individual bar coded packet 20 after folding and sealing has occurred.

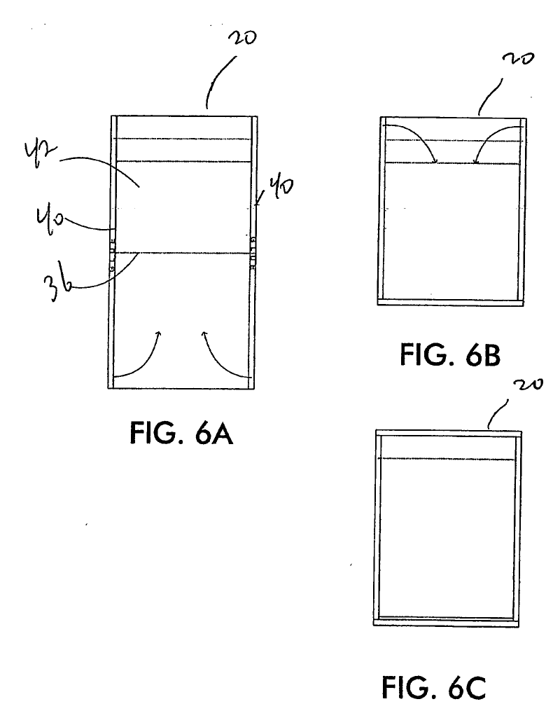

FIGS. 6A, 6B and 6C illustrate sealable individual bar coded packet 20 as the folding and sealing process occurs. The sealable individual bar coded packet 20 labels preferably contain a form of dry glue or other sealant portions 40 that enable the label to be formed into an individual packet (see FIG. 6A). Preferably, the printer 18 (FIG. 1) is equipped with an accessory for folding and/or sealing the sealable individual bar coded packet 20, preferably containing the medications. Further as shown in FIG. 6A, in the sealable individual bar coded packet 20 the glue or other sealant portion is provided near the perimeter and a polycoat portion 42 is provided near the center of the sealable individual bar coded packet 20. Polycoat is a preferred material in a sealable individual bar coded packet 20 because medication is well preserved therein.

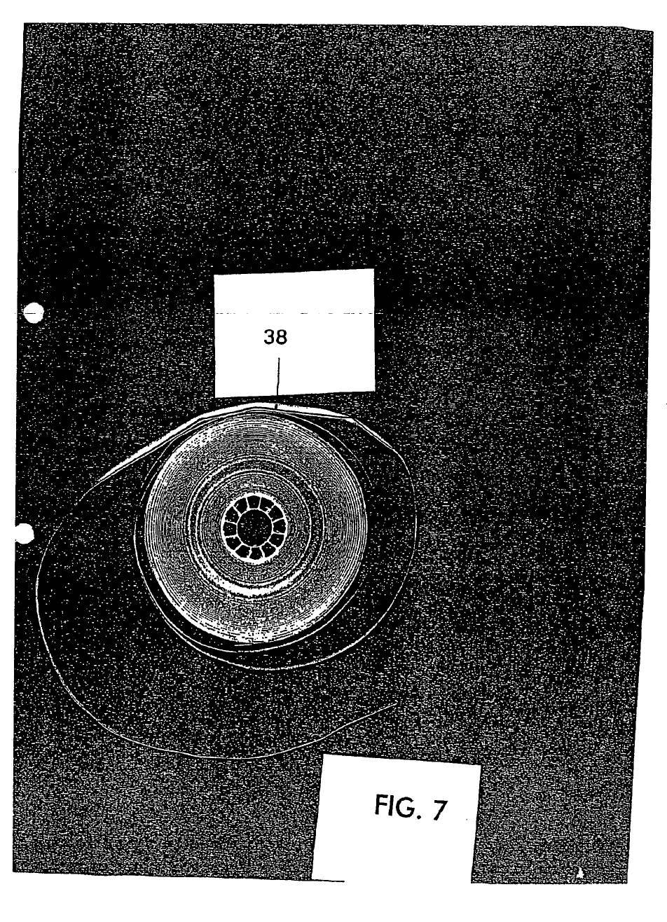

The sealable individual bar coded packet 20 may be available in a plurality of forms. FIG. 7 shows a plurality of sealable individual bar coded packets 20 that are provided as a single web of a roll of preprinted labels and available for passage through a thermal bar code printer. Each sealable individual bar coded packet 20 is defined between tear off perforations 38 at predetermined locations on the web that enable a person to tear individual labels off the web at the perforations.

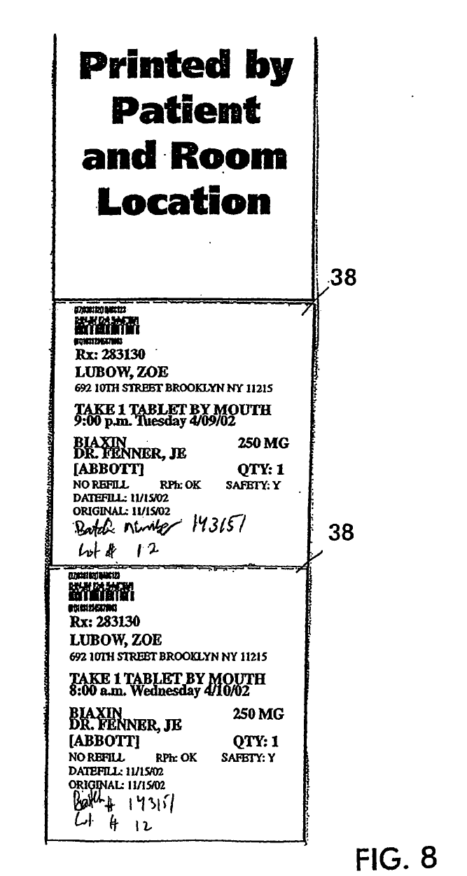

In another embodiment, shown in FIG. 8, a plurality of labels are printed in an accordion/fan shape. Each label is preferably tearable off the fan shape at predefined perforations 38 that separate adjacent labels. The printer is equipped with an accessory for folding the labels into an accordion/fan-type shape after labels are printed. This enables a person to receive a plurality of sealable individual bar coded packets 20 together in an accordion/fan shape.

In a preferred embodiment and as shown in FIG. 8, the first sealable individual bar coded packet 20 of a strip containing a plurality of sealable individual bar coded packets 20 that is printed provides information directed to the rest of the sealable individual bar coded packets 20 that are contained within the strip. For example, only the first packet acting as a marker, contains information that is directed to both the first packet and the following printed sealable individual bar coded packet 20.

In yet another embodiment, a series of labels are formed on a conventional paper sheet which is fed into, for example, a laser, impact, or ink jet printer, the sheet preferably is provided with perforations and scores for separating the labels and enabling folding of the labels and subsequent gluing to form individual packets. The labels can be formed into different sizes and shapes, depending upon the quantity and size of a medication that is to be inserted therein.

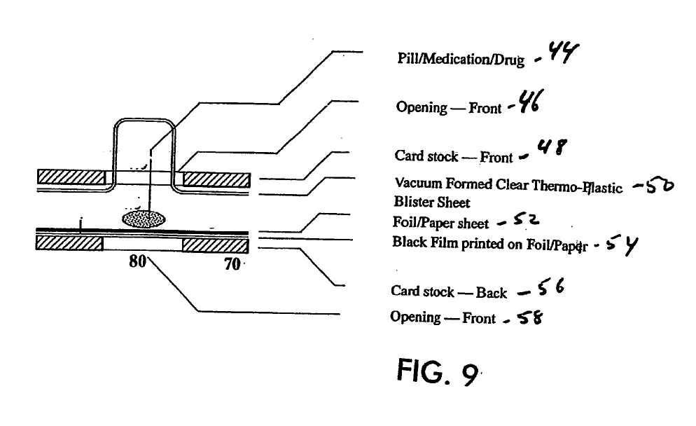

FIG. 9 shows an example blister pack packaging that can be used as an alternative embodiment of a sealable individual bar coded packet. As shown in FIG. 9, the example blister pack construction comprises two card stock sheets 48 and 56, with a plurality (e.g., 30, 50 or 90) holes punched in a layout of numbered rows and columns. To the backing is adhered a foil or paper laminate 52 for covering the plurality of holes. Preferably, a layer of black ink 54 is printed covering the entire surface of the of the film/paper 52 that appears through the punched holes in the opening 58 of the card stock 56.

The front card sheet 48 is also preferably punched with holes in a regular pattern of rows and columns to create a thirty, sixty or ninety hole count. A sheet of blisters that protrude through the card holes is preferably created from a vacuum formed sheet of thermoplastic.

In order to use the blister pack, the user punches the medication through the rear hole of the card stock 56, breaking the foil/paper 52 backing in the process. The plastic blister is preferably thin and flexible such to allow this movement.

The black ink layer 54 that is printed on the back of the foil/paper 52 is preferably burned away by the laser printing thereby leaving an RSS/CS bar code and a human readable portion in each cell unit.

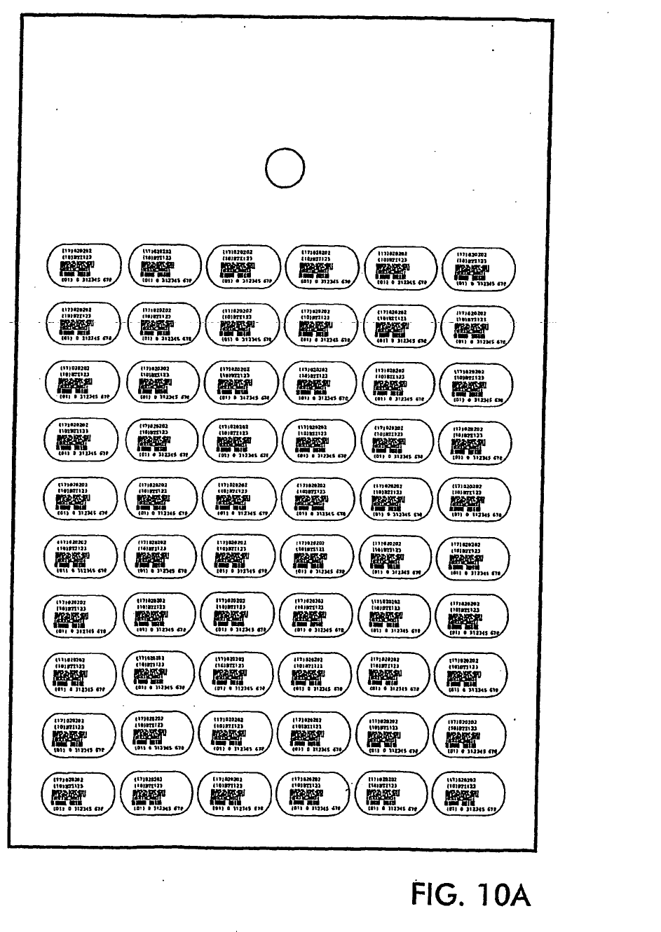

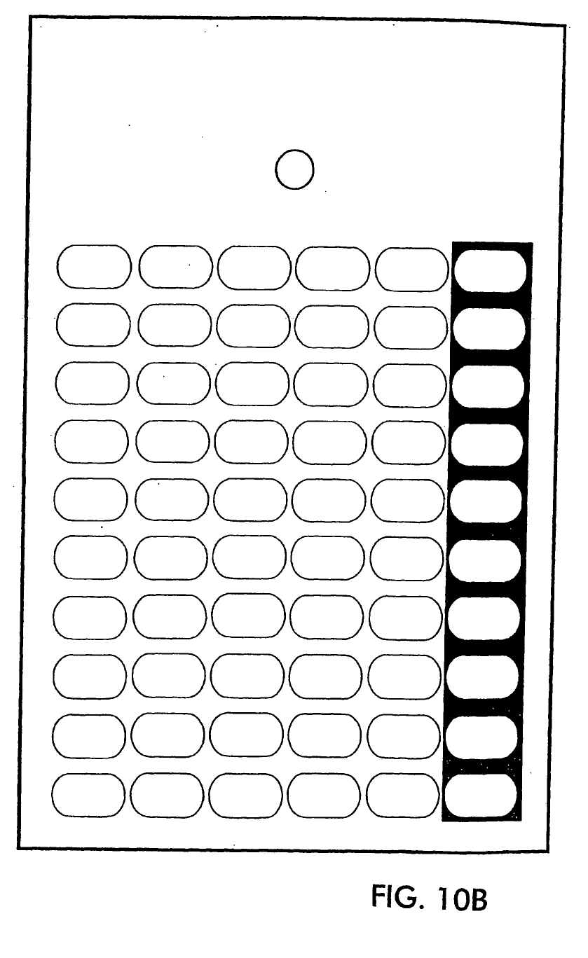

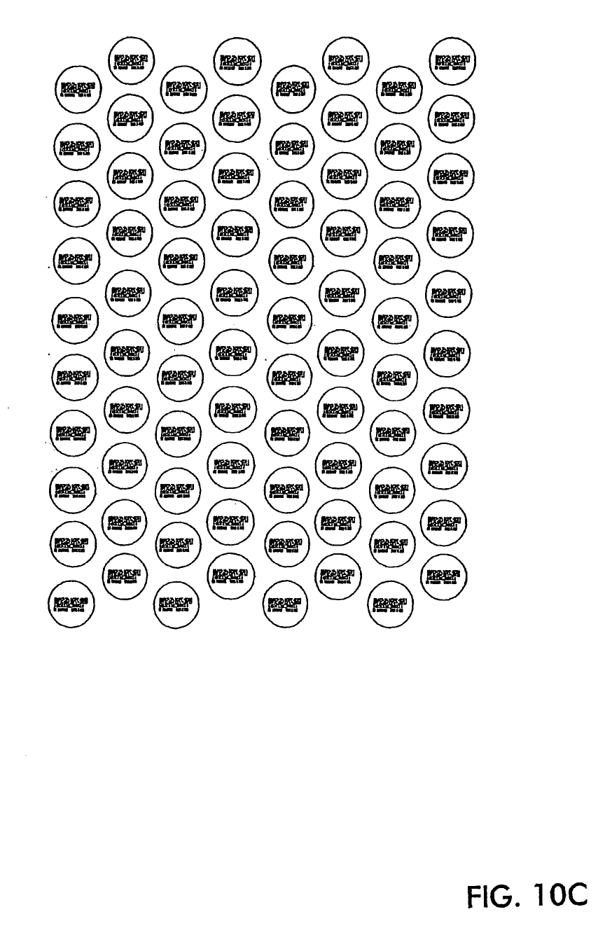

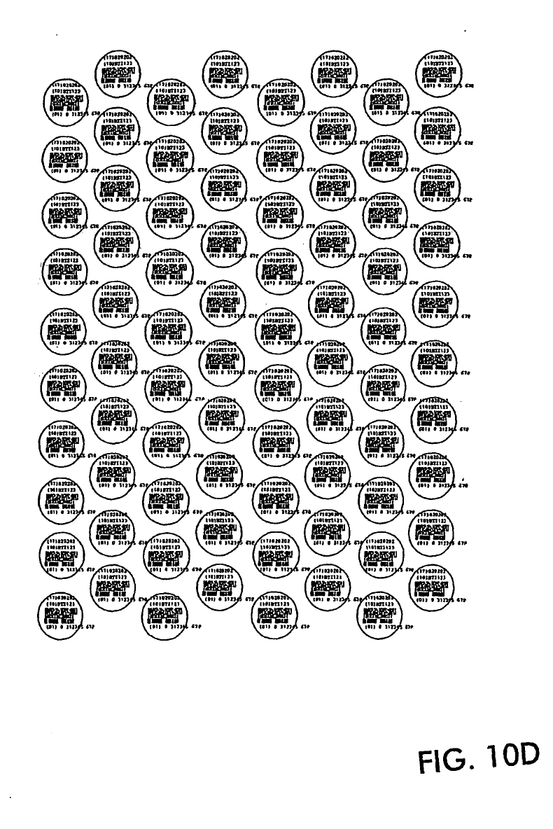

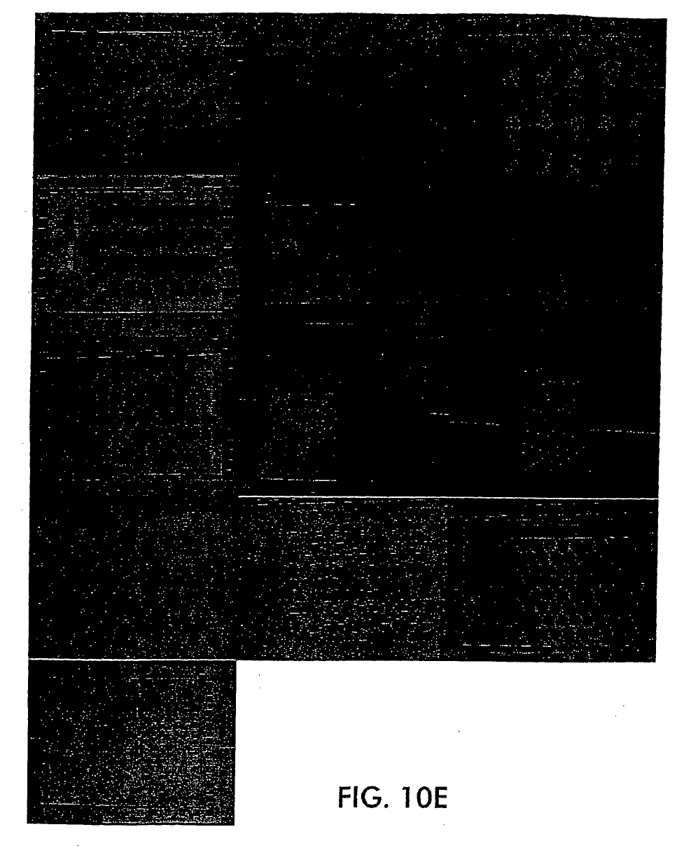

FIGS. 10A-10E show assorted types of of blister pack packaging in accordance with the present invention. The invention can be used with any known type of blister pack packaging.

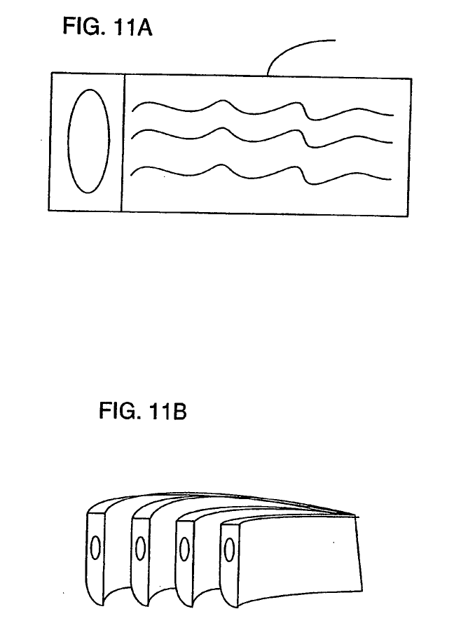

FIG. 11A illustrates an individual blister pack in accordance with the present invention. FIG. 11B illustrates a way to combine a plurality of blister packs.

Contents of Sealable Individual Bar Coded Labels

Preferably, and as shown in the example sealable individual bar coded packet of FIG. 4, a plurality of pieces of information are printed on the sealable individual bar coded packet 20 in both the form of a RSS/CS bar code and also preferably in the form of human readable characters. RSS/CS bar codes potentially hold thousands of characters of information. Additional human readable information is preferably printed on the sealable individual bar coded packets 20.

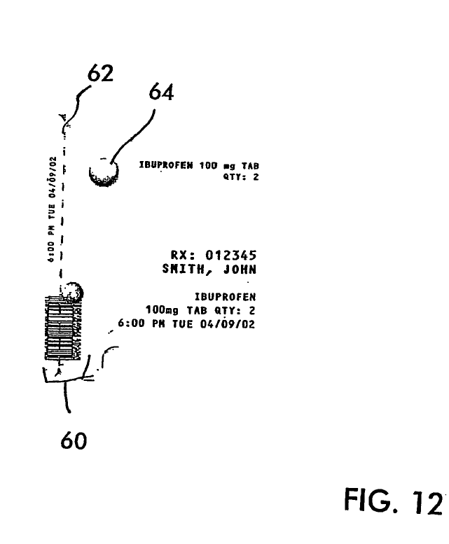

FIG. 12 shows an example sealable individual bar coded packet 20 that includes a removable tab or edge portion 60 that carries both human readable and machine readable information. The human readable information is preferably placed on the tab 60 such that when the tab is removed, for example, torn off along a perforation 62 in the sealable individual bar coded packet 20, the prescription medicine information, patient name, quantity, and date and time information, etc. are removed from the sealable individual bar coded packet 20. The linear portion, i.e., the RSS bar code, is preferably printed half or partially on the sealable individual bar coded packet 20 and half or partially on the removable tab 60. The CS portion of the bar code twice, i.e., adjacent to one half of the linear portion and again adjacent to the other half of the linear portion. After the tab is tom and removed from the sealable individual bar coded packet 20, an entire, machine-readable RSS/CS bar code is on both the removed tab and on the sealable individual bar coded packet 20.

Moreover and as shown in FIG. 12, an image 64 of the contents of the sealable individual bar coded packet is printed thereon, preferably in color. For example, an image of an individual tablet or capsule is printed on the packet so that when the packet is open and the contents are retrieved, a comparison can be made with the image that is printed on the sealable individual bar coded packet to ensure that the contents of the packet correspond. Other types of printed information, for example, pictorial information, can also be printed and include, for example, directions for types of foods that should be consumed or avoided when taking the medication and any other use or avoidance instructions.

In a further alternative embodiment, not shown, the labels at least in part comprise an at least partially transparent window that enables a person to see the contents of the sealable individual bar coded packet 20. This window enables a user to at least see the shape and color of the medication that is contained in the sealable individual bar coded packet 20.

The sealable individual bar coded packet 20 preferably includes an RSS/CS bar code that is printed thereon. That bar code preferably contains information directed to the patient and the medication. For example, patient demographics, patient medical history, allergies and the like are included in the bar code. Information directed to the medication, including batch and lot number, drug interactions, and information generated from a host of medical databases available over a global communication network may also be included. Furthermore, since the RSS/CS barcode can contain a relatively larger amount of information than other types of barcodes, the information in the RSS/CS bar code is preferably comprised of the GTIN, LOT EXPIRY DATE, concentration, and prescription record number of the medication and patient. Also printed on the sealable individual bar coded packet 20 there may be directions for use and intake in a human readable form for the benefit of the patient or the patient's care provider, including the time, date and other instructions regarding consumption of the medication.

Furthermore, a roll comprising a web of preprinted sealable individual bar coded packets 20 can be obtained by a party for filling prescriptions or supplying medications, and the roll is easily inserted in a printer and printed and/or folded and/or filled with medication at high speed (see FIG. 7). Additionally, a plurality of packet sizes are preferably available via the present invention, thereby accommodating different environments. For example, a drug company may decide to ship 500 individually packaged medications via the present invention and may place each individual medication in a small sealable individual bar coded packet 20. Alternatively, a plurality of medications may be incorporated into a single sealable individual bar coded packet 20, thereby requiring the use of a relatively large packet.

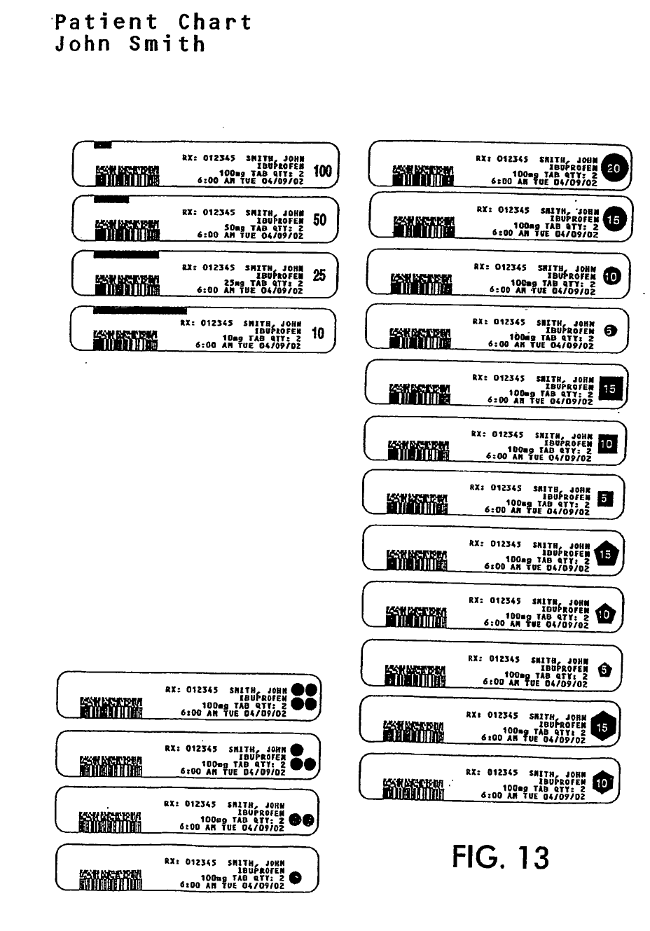

Furthermore, and as shown in FIG. 13, one or more shapes may be printed and the shapes are selected to provide information and meaning to the viewer. For example, a stripe and/or numerals can be used separately or in combination to indicate different things. On many prior art medication labels, available space is very small such that information is printed using a very small point size, or else omitted entirely. The present invention could solve this space problem by placing a shape, for example, a single bar, that, based upon the bar's relative size, represents meaningful information, e.g., dosage, frequency of use, time of day for ingestion, etc.

For example, a single bar that is longer than the width of the RSS/CS bar code printed on the label represents a dosage of 10 mg. of a specific medication, for example, ibuprofen. A similar bar that is printed on a different label, which has the same width as the RSS/CS bar code represents a different dosage, e.g., 25 mg. of ibuprofen. A single bar that is half of the width of the RSS/CS bar code represents 50 mg. of medication, and a bar that has a narrow width, for example, one quarter of the width of the RSS/CS bar code, represents a dosage of 100 mg. of ibuprofen. In the above examples, the single bar can be printed in conjunction with a number, for example, 10, 25, 50 and 100, respectively, to represent, for example, the varying dosages, time of day, etc. can be indicated too (see page 14).

The present invention also utilizes different shapes, for example, circles, squares or other polygons, to represent different kinds of information. For example, a small circle with an embedded number 5 represents, e.g., a dosage, quantity, day of the month, or other pertinent information that physicians, pharmacists, patients, or anyone else associated with the medication requires. The present invention further prints larger circles associated with different numbers to represent other information. For example, a slightly larger circle embedding the number 10, a larger circle with the number 15 embedded therein, and yet a larger circle having the number 20 embedded therein represent specific information directed to the medication, e.g., type of medication and a milligrams dosage level per tablet (see page 14).

Moreover, the imprints are not limited to circles or bars. A variety of polygons including six-sided, five-sided, four-sided and three-sided polygons, each having embedded numeral values therein can represent a plurality of information types, for example, medications, dosages, dates, floors in a hospital, etc. In this way, errors that can frequently occur, for example, due to illegible handwriting, are avoidable since a person using the present invention can easily view the label of the medicine and see a five sided polygon rather than a three-sided polygon, to avoid an error. For example, a three sided polygon may represent a weaker dosage than a six sided polygon. A nurse, or other healthcare provider, viewing the three-sided polygon can easily see that an incorrect dosage has been distributed for the patient.

A plurality of shapes on a single label may represent information directed to the medicine. For example, a single circle on a single label represents the first week of a month that a medicine is to be consumed, while three circles on a single label represent the third week of a month in which a medicine is to be consumed. Alternatively, the number of shapes on the label may be employed to indicate the number of dosages per day. In this way, errors that occur, for example, due to illegible handwriting, can be prevented by merely looking at a label and seeing an incorrect number of shapes on the label.

The use of bars and other shapes on labels has many applications in addition to labels for medicine. Any requirement for labeling information can utilize the system of graphic shapes as described herein. For example, labels directed to parts and components, tools, etc. all simplify and reduce errors by using the system shapes and/or numbers as directed by the present invention.

In accordance with the principles of the present invention, the employment of a plurality of shapes and numbers, for example, bars, circles and polygons, are printed on the sealable individual bar coded packet 20 to further provide information, for example, instructions and warnings, to the viewer of the label. The human readable markings are typically provided in addition to the bar coding. In a preferred embodiment, both the removable tab contains the shape and/or number, and the sealable individual bar coded packet 20 has the identical shape and/or number printed thereon. In this way, redundant information can be used for patient charts, or other information sources, with very little effort from a healthcare provider.

System and Use of Sealable Individual Bar Coded Labels

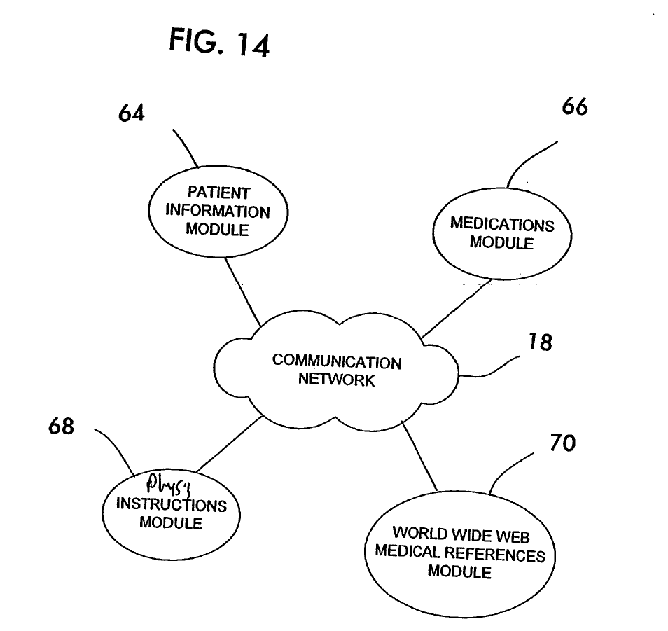

In accordance with the present invention, a plurality of hardware and software modules are integrated to produce the sealable individual bar coded packet. In the examples shown in FIG. 14, the modules comprised in the present invention include a patient information module 64, a medications module 66, a physician instructions module 68 and a worldwide web medical reference module 70. The patient information module 64 preferably contains information directed to patients or other persons receiving some sort of medical care. For example, the patient information module includes patient name, address, date of birth and other demographics type information. The medications module 66 comprises information regarding a plurality of medications, including, treatment suggestions, expiration dates, and any information related to an individual medication. The physician instructions module 68 preferably receives information from physicians via an user terminal 14. For example, a physician, while with a patient, enters instructions into a handheld computer and beams the instructions to the physician instructions module 68. Moreover, a worldwide web medical references module 70 is included in a preferred embodiment of the present invention. The module 70 includes, for example, a plurality of worldwide web pages available over the internet that include a plurality of information directed to medical care.

Preferably, instructions received from a physician are transmitted to a server system which processes the instructions and directs instructions to a printing device to produce the sealable, individual bar coded packets. In a preferred embodiment, a physician or care provider at the patient's location may use a portable device, for example, a personal digital assistant (PDA) as a user terminal 14 to input or receive information and instructions regarding the patient's medication into or from the portable device. Thereafter, information entered into the portable device may be transmitted to a receiving device, for example, into a personal computer via an infrared port, via a communication network. The information in the personal computer is transmitted to a server system and used to direct the printing of the sealable individual bar coded packet 20.

A plurality of databases that are presently available over the communication network may be accessed, and information that is relative to the specific patient and/or medication is electronically stored that may be retrieved and included for printing on the sealable, individual bar coded label 20. For example, batch and lot numbers directed to the medication, warnings regarding potential harmful combinations with other medications, drug recall information and the like may be retrieved from the plurality of databases. The information gathered from these plurality of sources are preferably compiled and printed on the label in at least one of human readable and machine readable form. Other information, for example, special orders that are received from the physician, is also preferably transmitted and printed on the sealable individual bar coded label.

Additionally, the one or more software modules causing the production of the sealable individual bar coded packets also transmit instructions to at least one printing device that causes the sealable individual bar coded packets to be printed in accordance with one or more rules. For example, a series of packets can be printed that are directed to a single patient. In this example, sealable, individual bar coded packets for an entire week's worth of medications are printed in a single print operation, the packets are filled with the appropriate medication, and the specific packets are delivered to the patient. Alternatively, the print operation is directed to print a plurality of sealable individual bar coded packets for a single medication. Further to this example, the same packet is produced a number of times, and a person simply tears off the sealable individual bar coded packet containing the medication and delivers the packet(s) containing the medication to an appropriate party.

After a physician or care provider prescribes medication for a patient, the information is transmitted to a server system and the server system or other computer system is directed to print the sealable individual bar coded packet 20, to dispense the medication into the packet, and then finally to seal the packet. In this way, little human intervention is required to fill a prescription.

During the step of dispensing the medication, a caregiver preferably uses a bar code reading device, such as a scanner, wand or other device, to read the contents of the patient's wrist band. Thereafter, the bar code printed on the sealable individual bar coded packet 20 is read, and a comparison occurs to ensure the caregiver is with the correct patient and the medication matches the physician instructions. Moreover, the patient record is electronically updated prior to the distribution of the sealable individual bar coded packets 20. A comparison is further made with the patient's record to ensure the medicine is correct. Furthermore, preferably, the caregiver visually inspects the sealable individual bar coded packet 20 to determine that the contents of the packet 20 match an image that is printed on the packet that represents the contents. After the electronic and visual confirmations are made, then the patient preferably receives the medication.

In one preferred embodiment, the patient is wearing a bar coded wristband. The blister pack cells, typically 30, 60 or 90 cells per blister pack, are individually bar coded and sequentially numbered. When the caregiver administers medications, all information is entered into an electronic monitoring database which records the patient wristband, date, time, medications, dosage and any other incidents that might occur during rounds.

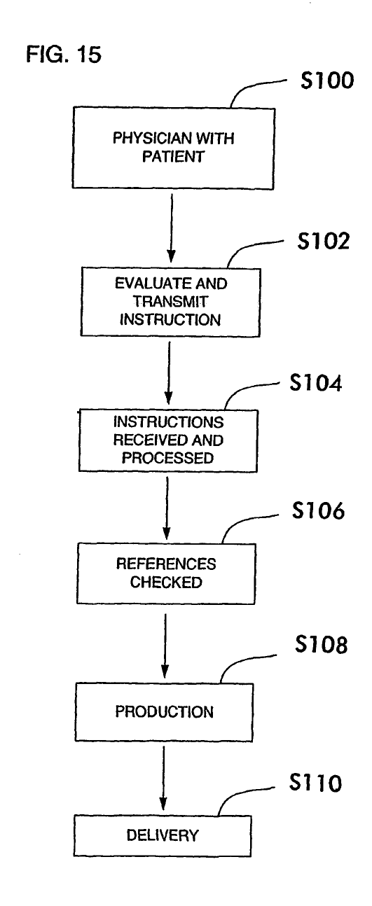

FIG. 15 is a flow chart that identifies some steps associated with the production and distribution of sealable individual bar coded packets 20 in accordance with the present invention. Further to this example, a physician meets with a patient (step S100). The physician preferably evaluates the patent, and enters a prescription with accompanying instructions into a personal digital assistant (PDA) and transmits the instructions via an infrared port to a computer system (step S102). In step S104, the instructions are received and processed. For example, the instructions are formatted to begin production of sealable individual bar coded packets 20. In step S106, references are checked before proceeding with production of the sealable individual bar coded packets 20. For example, a medication may have been recalled and the reference check would discover and report such information to the physician. In step S108, production of a sealable individual bar coded packet 20 occurs. Details of the contents and printing, folding and sealing of the sealable individual bar coded packet 20 are described above. Finally, in step S1110, the sealable individual bar coded packets 20 are distributed. Further to this example, a plurality of medications, for example, medication for a week can be ordered and filled in a packet or packets without any human contact with the packets.

The present invention has many advantages over the prior art. For example, the medications are sealed in inexpensive, disposable and/or recyclable packets. This eliminates the need to produce plastic vials which are more expensive and potentially harmful to the environment in production and later disposed. Moreover, no separate label application step is needed to place a label on a separate container, for example, a vial, thus saving operator time and eliminating a human step which has potential for error.

Additionally, multiple sealable individual bar coded packets 20 can be produced on a single sheet or web or roll, thereby increasing productivity and decreasing costs. Additionally, the many interfaces with which drug databases via a global communication network can be accessed increases the amount of information that can be integrated and presented to physicians and patients via the present invention. Properly marked, individually wrapped bar coded medications allow for the medication to remain hermetically sealed, and delivered via an automated healthcare delivery system which may include all of the checks and safeguards a computerized system may allow.

Other advantages of the present invention include efficiency, a decrease of errors caused by human intervention, decreased costs and increased efficiency.

Although the present invention has been described in relation to particular embodiments thereof, many other variations and modifications and other uses will become apparent to those skilled in the art. For example, the sealable individual bar coded packets 20 can be used for hardware, such as screws, nuts, bolts and the like. Further, small parts that are included with items that require some assembly can be stored in sealable individual bar coded packets 20.

Therefore the present invention is not limited by the specific disclosure herein.

1. A foldable and sealable packet, the packet comprising:
folding perforations on the packet to define locations for folding;
a sealant, wherein the sealant maintains the shape of the packet after the packet is folded at the folding perforations, wherein after the packet is folded and at least partially sealed, the packet is formed to become a container to receive the contents; and
a bar code on the packet, the bar code containing information directed at least to contents of the packet.

2. The foldable and sealable packet of claim 1, wherein the contents include at least one of medication and hardware.

3. The foldable and sealable packet of claim 2, wherein the medication includes at least one of capsules, tablets, gelcaps, dissolving strips, and caplets.

4. The foldable and sealable packet of claim 1, further comprising human readable information printed on the packet.

5. The foldable and sealable packet of claim 4, wherein the human readable information is directed to at least one of a patient who is intended to receive the packet, the contents of the packet, and instructions for opening the packet.

6. The foldable and sealable packet of claim 1, further comprising an image that represents the contents of the packet.

7. The foldable and sealable packet of claim 1, further comprising a polycoat portion.

8. The foldable and sealable packet of claim 1, further comprising a tear off perforation portion enabling the removal of individual foldable and sealable packets in a strip of foldable and sealable packets.

9. The foldable and sealable packet of claim 1, wherein the bar code is a RSS/CS barcode.

10. The foldable and sealable packet of claim 1, wherein the packet comprises blister packs.

11. The foldable and sealable packet of claim 10, wherein the blister packs are formed with at least one of a paper and film portion having an ink layer disposed thereon, and wherein the ink layer is adapted to be removed by a laser.

12. The foldable and sealable packet of claim 10, further comprising a RSS/CS bar code fomed in the at least one of paper and film by the removal of the ink by the laser.

12. The foldable and sealable packet of claim 1, wherein a first of a plurality foldable and sealable packets comprises information regarding the remaining ones of the foldable and sealable packets in the strip.

13. The foldable and sealable packet of claim 1, further comprising a removable tab portion.

14. The foldable and sealable packet of claim 13, wherein the removable tab portion comprises a CS portion of a RSS/CS bar code and a part of a linear portion of the RSS/CS barcode, and the portion of the foldable and sealable packet adjacent to the tab portion comprises another substantially identical CS portion and another part of the linear portion.

15. The foldable and sealable packet of claim 14, wherein the removable tab, when removed, comprises a copy of the RSS/CS barcode on the portion of the foldable and sealable packet of claim adjacent to the tab portion.

16. The foldable and sealable packet of claim 1, further comprising an at least partially transparent window that enables a person to see the contents of the foldable and sealable packet.

17. The foldable and sealable packet of claim 1, further comprising a plurality of foldable and sealable packets formed in a web of a roll of foldable and sealable packets.

18. The foldable and sealable packet of claim 1, further comprising at least one shape printed on the foldable and sealable packet, wherein the shape represents information directed to at least one of the contents of the foldable and sealable packet and the person who receives the foldable and sealable packet.

19. The foldable and sealable packet of claim 18, wherein the at least one shape is formed as at least one of a polygon, a bar, and a circle.

20. The foldable and sealable packet of claim 18, wherein the information regards at least one dosage, frequency of use, time of day for ingestion and warnings directed to the contents of the foldable and sealable packet.

21. A method for producing a foldable and sealable packet, the method comprising:
storing electronic patient information in a database, the electronic patient information representing at least a patient;
storing electronic medication information in at least one of the database and another database, the electronic medication information representing information regarding at least one of a plurality of medications;
providing at least one of the electronic patient information and the electronic medication information to a patient caregiver;
receiving electronic instructions from the patient caregiver, the electronic instructions comprising instructions directed to medication for the patient;
printing at least a bar code on the foldable and sealable packet;
dispensing at least one medication in the foldable and sealable packet; and
folding and sealing the foldable and sealable packet such that the packet becomes a container for the at least one medication.

22. The method of claim 21, further comprising referencing at least one Internet web page to discover information directed to the at least one medication.

23. The method of claim 21, wherein the step of receiving electronic instructions comprises receiving information that are electronically beamed from a personal digital assistant.

24. The method of claim 21, further comprising printing human readable information on the foldable and sealable packet.

25. The method of claim 24, wherein the human readable information comprises at least one of a medication warning, drug recall information, batch number, lot number, patient information, medication fill date, medication quantity, dosage, and directions for consumption.

26. A method for dispensing medication to a patient, the method comprising:
electronically receiving caregiver instructions, said caregiver instructions representing information regarding medication for the patient;
printing of a foldable and sealable packet;
folding of the foldable and sealable packet;
dispensing at least one medication into the foldable and sealable packet;
sealing the foldable and sealable packet;
and distributing the foldable sealable packet containing the at least one medication to the patient.

27. The method of claim 26, wherein the step of distributing the medication further comprises:
reading a bar code image on a wrist band worn by the patient to extract wrist band information;
reading a bar code image on the foldable and sealable packet to extract content information, the content information representing the contents of the foldable and sealable packet;
comparing the wrist band information with the content information; and
providing the patient with the foldable and sealable packet containing the medication after confirming the wrist band information corresponds with the content information.

28. The method of claim 14, wherein the bars of the linear portion extend continuously from the foldable and sealable packet to the removable tab portion.
